(19) United States
(12) Patent Application Publication
(10) Pub. No.: US 2002/0023912 A1
(43) Pub. Date: Feb. 28, 2002

(54) 12-volt heated coffee mug

(76) Inventors: Roy McGee, Little Rock, AR (US); Francina McGee, Little Rock, AR (US)

Correspondence Address: Law Offices John D. Gugliotta, P.E., Esq., 202 Delaware Building, 137 South Main Street, Akron, OH, 44308, US

(21) Appl. No.: 09/934,349

(22) Filed: Aug. 21, 2001

Related U.S. Application Data
(60) Provisional application No. 60/226,837, filed on Aug. 22, 2000.

(51) Int. Cl. H05B 3/06

(52) U.S. Cl. 219/432; 219/433

(57) ABSTRACT

A 12-Volt Heated Coffee Mug is designed for the holding and drinking of hot beverages. The cup, with lid and handle, sits in a matching base with heating elements powered by 12 volts DC as provided by a motor vehicle to maintain the hot temperature of the liquid. The matching base assures not only a tight coupling to prevent the cup from tipping over while driving, but also to insure that good heat transfer will occur from the heating coils to the liquid. The matching base has a wide base to provide stability on a horizontal surface while traveling in a motor vehicle.

### RELATED APPLICATIONS

The present invention is a continuation of U.S. Provisional Patent No. 60/226,837 filed on Aug. 22, 2000.

### BACKGROUND OF THE INVENTION

1. Field of the Invention

The present invention relates generally to electrically heated devices combined with containers and, more particularly, to a coffee mug capable of being electrically heated.

2. Description of the Related Art

Coffee, tea and other hot beverages are enjoyed by people almost every day. Many people cannot start their day without a cup of their favorite hot beverage. However, the start of the day also means a long commute in a car for many people The popularity of travel mugs is evidence of the amount of coffee that is drunk while driving. For many people, a commute time of 45 minutes to an hour is not uncommon. Even in the best insulated coffee mug, hot beverages will cool to an unacceptable level during this time. Even those who do not regularly commute long distances suffer when vacationing or taking long trips on the weekend. Car rides of two hours or more are not uncommon during such trips, and hot beverages will become almost undrinkable before they can be replaced at the next rest stop.

A search of the prior art did not disclose any patents that read directly on the claims of the instant invention; however, the following references were considered related.

The following patents disclose a portable heated cup with a motion sensor and timer.

U.S. Pat. No. 6,013,901 issued in the name of Lavoie

U.S. Pat. No. 5,508,494 issued in the name of Sarris et al.

The following patents describe an electrically-heated warming device for a receptacle.

U.S. Pat. No. 5,773,795 issued in the name of Messmer

U.S. Pat. No. 4,1165,456 issued in the name of Dogliotti

The following patents disclose the ornamental design for a ceramic electric heater in the form of a cup seat.

U.S. Pat. No. D 388,509 issued in the name of Hsiao

U.S. Pat. No. D 388,508 issued in the name of Hsiao

U.S. Pat. No. 5,509,348 issued in the name of Klawuhn et al. describes a coffee maker for pre-heating and keeping warm of cups.

U.S. Pat. No. 3,549,861 issued in the name of Trachtenberg et al. discloses a self-heated, hermetically-sealed thermos bottle.

U.S. Pat. No. D 243,498 issued in the name of Pianezza describes the ornamental design for a cordless, electrically-heated cup.

Consequently, need has arisen for a solution to these problems associated with drinking hot beverages while in a motor vehicle for long periods of time.

### SUMMARY OF THE INVENTION

It is therefore an object of the present invention to provide an improved device for drinking hot beverages while in a motor vehicle for long periods of time.

It is a feature of the present invention to provide an improved coffee mug capable of being electrically heated

Briefly described according to one embodiment of the present invention, a 12-Volt Heated Coffee MIJg is a cup designed for the holding and drinking of hot beverages. The cup, With lid and handle, sits in a matching base with heating elements powered by 12 volts DC as provided by a motor vehicle to maintain the hot temperature of the liquid. The matching base assures not only a tight coupling to prevent the cup from tipping over while driving, but also to insure that good heat transfer will occur from the heating coils to the liquid. The matching base has a wide base to provide stability on a horizontal surface while traveling in a motor vehicle. The base also has a control switch to turn the invention off or allow it to operate at high or low settings. The invention can be used with coffee, tea, hot chocolate, broth,, or any other beverage that is commonly enjoyed hot.

The use of the present invention allows one to drink a hot beverage while traveling in a motor vehicle regardless of the distance traveled or the length of time spent in the motor vehicle.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the preferred embodiment of a heated coffee mug according to the present invention; and

FIG. 2 is an electrical schematic diagram for use therewith.

### DESCRIPTION OF THE PREFERRED EMBODIMENTS

The best mode for carrying out the invention is presented in terms of its preferred embodiment, herein depicted within the FIGS.

1. Detailed Description of the Figures

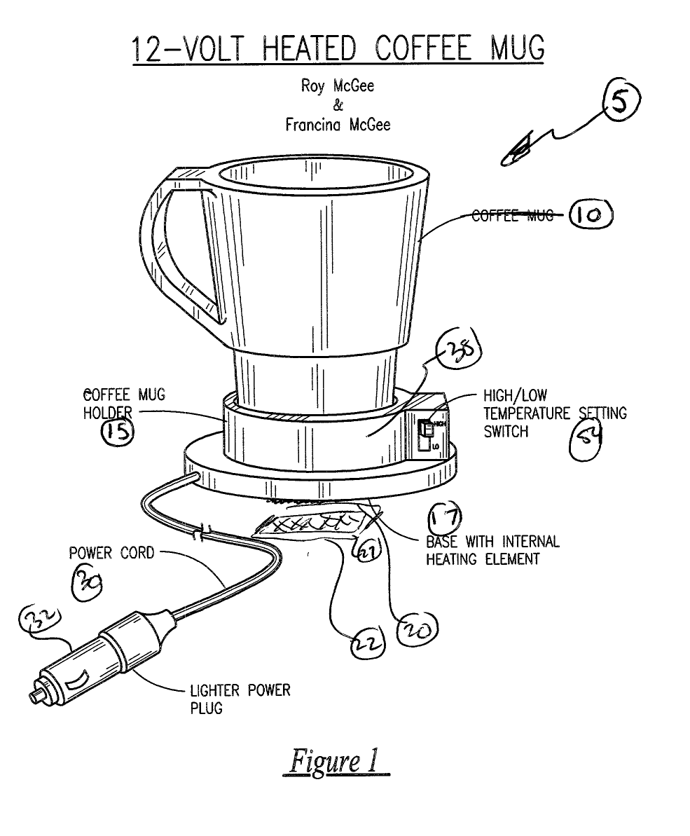

Referring now to FIG. 1, a heated coffee mug apparatus 5, according to the preferred embodiment of the present invention, provides generally a standard drinking vessel 10, surrounded by and in firm mechanical communication with a coffee mug holder 15. The mug holder 15, which will be described in greater detail below, comprises a radially elongated base 17, wrapped around the lower circumference of the drinking vessel 10. The base 17 has a flat lower surface for resting upon a horizontal surface, but also can be held in place via a first hook fastening means 20 and a loop fastening means 22. The first hook fastening means 20 is secured to the base 17, via adhesive or similar material. The loop fastening means 22 is secured to a flexible fabric strap 27. The flexible fabric strap 27 is secured to the horizontal surface by tape or other similar adhesive.

Electrical power is supplied to the base 17 via a power cord 30. The power cord 30 is electrically coupled with a power plug 32. The power plug 32 is capable of connecting directly to a motor vehicle's power system. The power plug 32 is also capable of connecting to a power receptacle. The power receptacle 35 is electrically coupled to a heating element 28 via a power cord 39 as described below.

The heating element comprises a flexible resistive type heat element 50 located on the is on the interior side of the coffee mug holder 15, to provide heat via direct mechanical communication to the standard containerized food vessel 10 (shown in FIG. 1). Located directly above, but not in direct mechanical communication with the flexible resistive type heat element 50, is a controlling thermostat 54. The controlling thermostat 54 is provided with a pair of fixed set points of 130 degrees Fahrenheit for high and 110 degrees Fahrenheit for low. Occupying the remainder of the space within the coffee mug holder 15 is an insulating media (not shown), which is used to direct the heat from flexible resistive type heat element 50 into the standard drinking vessel 10, and protect the user from direct contact with high temperatures.

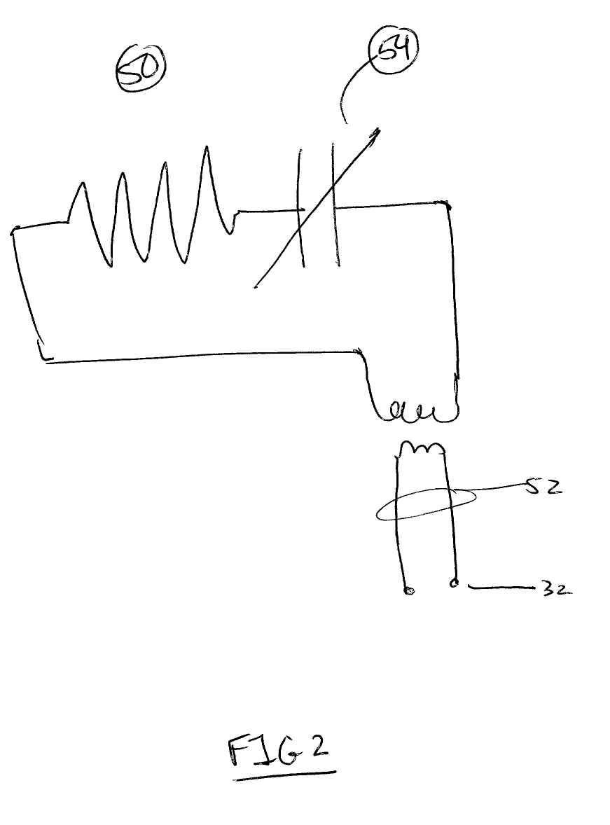

Referring now to FIG. 2, an electrical schematic diagram illustrating the electrical components is shown. The flexible resistive type heat element 50 is connected in a series arrangement with the controlling thermostat 54, the power cord 30, and the power plug 32. As can be visualized via this arrangement, the controlling thermostat 54, will provide the regulation required for safe operating conditions. Additionally, FIG. 2 depicts the power receptacle 35, the power cord 39, and the power pack 37. The power pack 37, consists of a step-down transformer 60, and an electrical connector 62, to allow for connection to standard alternating current electrical power systems as found in residences and businesses.

2. Operation of the Preferred Embodiment

In operation, the present invention can be utilized by the common user in a simple and effortless manner. To use the present invention with its preferred embodiment can be best described in conjunction with the perspective view of the electrically operated coffee mug in FIG. 1.

Referring to FIG. 1, the user secures the base 17 to a horizontal surface with the flexible fabric strap 27. The user then applies electrical power by connecting the power plug 32 to a suitable source of electric power associated with a motor vehicle power system. The power receptacle 35, the power pack 37, and the power cord 39, are utilized by an individual when the electrically operated coffee mug apparatus 5, is operated where standard alternating current power is available, such as inside a residence or industrial/commercial building.

Once electrical power is applied, the flexible resistive type heat element 50 produces heat through resistive means. This heat is then transmitted through the standard containerized food vessel 10, and ultimately to the beverage product located inside.

The foregoing description of the preferred embodiment of the present invention has been presented for purposes of illustration and description. It is not intended to be exhaustive or to limit the present invention to the precise form disclosed, and obviously many modifications and variations are possible in light of the above teachings.

The preferred embodiment was chosen and described in order to best explain the principles of the present invention and its practical application to those persons skilled in the art, and thereby to enable those persons skilled in the art to best utilize the present invention in various embodiments and with various modifications as are suited to the particular use contemplated. It is intended that the scope of the present invention be broadly defined by the claims which follow.

What is claimed is:

1. A heated coffee mug comprising:
a cup with a handle and forming an upper opening orifice;
a lid for affixing to said cup to enclose said upper opening orifice;
a base for receiving said cup and provide stability on a horizontal surface; and
heating elements retained within said base, said heating elements powered by 12 volts DC as provided by a motor vehicle to maintain the hot temperature of the contents of said cup.

2. A heated coffee mug apparatus 5 comprising:
a generally standard drinking vessel;
a mug holder for surrounding and providing firm mechanical communication with said drinking vessel, said mug holder having a base having a flat lower surface for resting upon a horizontal surface;
a heating element located within said mug holder; and
a power cord electrically coupled with a power plug and in electrical communication with said heating element.

3. The heated coffee mug apparatus of claim 2, wherein said power plug is capable of connecting directly to a motor vehicle's power system.

4. The heated coffee mug apparatus of claim 3, wherein said power plug is also capable of connecting to a power receptacle.

5. The heated coffee mug apparatus of claim 2, wherein said heating element comprises a flexible resistive type heat element located on the interior side of the coffee mug holder, to provide heat via direct mechanical communication to the standard containerized food vessel

6. The heated coffee mug apparatus of claim 2, wherein said heating element further comprises a controlling thermostat provided with a pair of fixed set points.
